(19) United States
(12) Patent Application Publication
(10) Pub. No.: US 2002/0144834 A1
(43) Pub. Date: Oct. 10, 2002

(54) Boiler for a hardened voyage data recorder

(76) Inventor: Gregory W. Purdom, Sarasota, FL (US)

Correspondence Address: Joseph J. Kaliko, 73 Rogers Rd., Stamford, CT, 06902, US

(21) Appl. No.: 09/899,646

(22) Filed: Jul. 6, 2001

Related U.S. Application Data
(60) Provisional application No. 60/282,821, filed on Apr. 10, 2001.

(51) Int. Cl. H02G 3/08

(52) U.S. Cl. 174/52.1

(57) ABSTRACT

A hardened voyage data recorder includes two subsystems: a removable non-volatile memory module and a base containing electronics and firmware for communicating with data sensing systems and for accessing the memory. According to the invention, the memory is a stacked BGA memory protected in a “boiler” which is designed to tolerate a low temperature fire environment for a relatively long term. The boiler and the memory module subsystem are designed to withstand penetration forces associated with marine accidents. Cabling from the memory is arranged so that the structural integrity of the boiler is not compromised.

This application claims the benefit of Provisional Application serial number 60/282,821 filed Apr. 10, 2001, the complete disclosure of which is hereby incorporated by reference herein.

This application is related to co-pending co-owned application serial number __/___,___ entitled “Hardened Data Voyage Recorder”, filed simultaneously herewith, the complete disclosure of which is hereby incorporated by reference herein.

### BACKGROUND OF THE INVENTION

1. Field of the Invention

The invention relates to methods and apparatus for recording data concerning the operation of a sea borne vessel. More particularly, the invention relates to methods and apparatus for recording and protecting data leading up to an accident or “incident”. Further, the invention relates generally to methods and apparatus for protecting heat sensitive items, such as solid state memory devices used in a marine data recorders and the like, from heat that may be produced from fire following a marine accident. The invention also relates generally to methods and apparatus for protecting such items from shock damage and the affects of moisture.

2. Brief Description of the Prior Art

It has long been noted that the investigation of maritime accidents and incidents could benefit from the recording of data and audible commands occurring aboard ships. Indeed, many considered this an inevitable technological extension of the time-honored ship's logbook. This desire has culminated in the development of an international standard governing the performance of a Voyage Data Recorder (VDR).

In 1974 the Safety of Life at Sea (SOLAS) Convention of the International Maritime Organization (IMO) acknowledged the value and expressed the desire of having recorders on ships similar to the “black box” flight recorders for aircraft. This began a long process of establishing international standards and requirements for a Voyage Data Recorder (VDR).

In 1996, VDR requirements, which had been debated for a long time, began to emerge in the navigation and electronics subgroup (NAV) of the IMO. Anticipating an eventual IMO resolution concerning VDRs, IEC (International Electrotechnical Commission) TC80 formed WG11, which began structuring a specification based on preliminary drafts of the NAV requirements. The IMO passed resolution A.861 (20) in November 1997 and the IEC standard 61996 was completed as a Committee Draft for Voting in March 1999. The specification was published in August 2000.

The IEC 61996 Ship Borne Voyage Data Recorder Performance Requirements describes data acquisition and storage functions and refers to a “protective capsule” and a “final storage medium”. Architecture for complying with this standard has emerged with two major components.

In the first component, the ship's interfaces, data acquisition, and soft recording functions are encompassed in a Data Management Unit (DMU). The DMU is intended for installation in the relatively benign environment of the bridge. The second component is the Hardened Voyage Recorder (HVR) which encompasses the protective capsule and final storage medium. The HVR is designed for survivability and recoverability. It is intended for external installation on the bridge deck or on top of the superstructure.

The primary function of the Hardened Voyage Recorder (HVR) is to protect the data acquired by the Voyage Data Recorder (VDR) so that the data can be used during accident or “incident” investigation.

Previously incorporated co-owned co-pending serial number __/___,___ discloses details related to the electronics and software of the HVR. The present application relates to the physical details of the “protective capsule” containing memory. The protective capsule must protect the memory from impact damage, thermal damage and moisture damage.

It is known in the art of aircraft flight recorders to use a “boiler” to protect memory from thermal damage. A “boiler” is defined herein as a multiple (two or more) compartment containment structure which may be used to separate a thermal mass (such as water) from devices (such as solid state memory devices) being protected.

U.S. Pat. No. 5,750,925, entitled “Flight Crash Survivable Storage Unit With Boiler For Flight Recorder Memory”, issued May 12, 1998, originally assigned to Loral Fairchild, Corp. (Purdom et al.), the complete disclosure of which is incorporated herein by reference, describes one such “boiler”. More particularly, the '925 patent describes a unit designed to withstand temperatures of 1100 degrees C (approximately 2000 degrees F), which is defined herein to be a “high temperature” environment for a relatively short term.

Although the unit described in the '925 patent is suitable for protecting heat sensitive components (like solid state memory) in a high temperature environment, such as the environment that often accompanies aircraft fires; problems germane to the survivability of heat sensitive components following a marine crash are very different from those arising following an air disaster and are not addressed by Purdom et al., or indeed any known marine recorders.

In particular, marine recorders need to be able to survive in “low temperature” fires, i.e., a fire defined herein to be burning (or smoldering) at 260 degrees C for a relatively long term, e.g. 10 hours, as opposed to aircraft recorder high temperature industry survivability specifications of being able to withstand an 1100 degree C environment for 1 hour.

Low temperature fires were not a problem with prior art protective units, such as the one described in the incorporated '925 patent, because those units used “TSOP” (thin small outline package) memory components, with leads extending therefrom. As a result, even if a board could not (or did not) survive a low temperature fire, the memory chips that did survive and could be “reworked”, i.e., be placed on another board easily and read.

In the present application (marine recorder application) low temperature fire survivability at the board level becomes very important since it is desirable to use “BGA” (ball grid array) packages for memory components. These smaller packages can be more densely packed, use less “real estate”, etc.; but suffer from the constraint that connections are made under the device. I.e., no leads extend out from the periphery of a BGA package (like they do from a TSOP) which could make board reworking after a low temperature fire difficult or impossible. Nevertheless, the BGA design is otherwise desirable for the reasons indicated hereinabove and for other reasons described below.

For example, it is further desirable to use BGA packaging since the spacing between connections is larger than with TSOP. This fact enhances unit reliability since it is easier to prevent solder bridges. In addition to a more reliable unit, a unit utilizing BGA memory is easier to fabricate.

Thus, even though no leads extend therefrom and it is more difficult (or impossible) to rework a memory storage unit if a board is destroyed in low temperature fire, it is nevertheless desirable to provide and protect (in the marine context) BGA memory, i.e., provide a boiler protected BGA solid state memory that can survive a low temperature fire at board level over relatively long term.

Further, using the '925 patent as a frame of reference, the boiler described in that patent does not provide the mechanical strength required for marine applications. More particularly, marine applications standards addressing “penetration” are different from those for flight recorders since the size of objects involved in a marine accident are typically considerably larger than the relative light weight pieces of an aircraft involved in an air crash.

As a result, energy is not absorbed by the penetrator (penetrating object) breaking up. Since the objects, such as ship components or ships themselves, are relatively larger and heavier (compared with aircraft parts), and all of a penetrator's energy could be directed towards the boiler, structural considerations for using a boiler in the marine context is a serious new problem that did not exist in the flight recorder context. The shape, structure and materials used for a marine boiler becomes an issue if the boiler is to survive and perform its protective function.

Further problems exhibited by prior art boilers, including the one described in the '925 patent, limit their suitability for use in marine applications. In particular, the cabling exiting design used in connection with such boilers is not acceptable for marine applications. This is because it impacts the structural integrity of the boiler itself rendering it unsuitable for the marine environment.

It may be seen with reference to the '925 patent that the cable exits the boiler via a rectangle cut out of plate edge; this is a point of weakness in the lid.

### SUMMARY OF THE INVENTION

It is therefore an object of the invention to provide a Hardened Voyage Recorder which meets or exceeds the requirements of the IEC 61996 test specifications.

It is also an object of the invention to provide a Hardened Voyage Recorder which incorporates a memory unit protected in a boiler.

It is another object of the invention to provide a Hardened Voyage Recorder which includes a boiler which is capable of withstanding a low temperature fire for a relatively long term.

It is yet another object of the invention to provide a Hardened Voyage Recorder which utilizes BGA memory.

It is another object of the invention to provide a Hardened Voyage Recorder which includes a boiler with improved cable routing such that the integrity of the boiler is not compromised.

It is still another object of the invention to provide a Hardened Voyage Recorder which includes a boiler having an improved cover.

It is yet another object of the invention to provide a Hardened Voyage Recorder which includes a stacked memory protected by a boiler.

In accord with these objects which will be discussed in detail below, the Hardened Voyage Recorder (HVR) according to the invention includes two separable subassemblies. The first subassembly is a mounting base subassembly designed to be directly fastened to the ship and provide a watertight cable entry for power and data connections. The second subassembly is a removable hardened memory subassembly which is attached to the mounting base with a quick releasing clamp.

The hardened memory subassembly has a bracket for an externally mounted underwater location beacon with dual activation moisture sensors to avoid inadvertent activation due to spray, rain, or hosing off. The HVR is preferably painted a highly visible florescent orange with white reflective labels. The reflective labels contain the required text: VOYAGE DATA RECORDER, DO NOT OPEN, REPORT TO AUTHORITIES.

The mounting base subassembly includes electronics for receiving data and writing data to the memory in the hardened memory subassembly as disclosed in more detail in previously incorporated serial number __/___,___ filed simultaneously herewith.

The removable hardened memory subassembly preferably includes 1.5 gigabytes of BGA solid state memory arranged in a stack which is protected in a boiler. According to the presently preferred embodiment, the hardened memory subassembly includes a substantially cylindrical stainless steel “bell” containing a substantial layer of insulation defining a cylindrical well for receiving the boiler.

The boiler according to the invention includes a bifurcated cylindrical member, one portion of which is a thermal expansion cavity adapted to contain a phase change material or “thermal mass” which acts as a heat sink. The other portion of the bifurcated cylindrical member defines a storage compartment for a stacked memory.

According to the presently preferred embodiment, a ribbon cable extends from the last memory board in the stack and through a circular opening spaced away from the edge of a stainless steel cover. The boiler is disposed in the cylindrical well defined by the insulation in the bell. A silicone rubber pad is placed over the ribbon cable to protect it an a cylindrical insulator is placed in the cylindrical well to fill it. A stainless steel cover used to hold insulation and the boiler into the bell is locked into the bell by two snap rings.

### BRIEF DESCRIPTION OF THE DRAWINGS

FIG. 1 is a perspective view of an HVR according to the invention;

FIG. 2 is a side elevation view of an HVR according to the invention;

FIG. 3 is a side elevation view of the hardened memory subassembly with the beacon bracket removed;

FIG. 4 is a sectional view taken along line A-A in FIG. 3;

FIG. 5 is an exploded perspective view of a boiler according to the invention;

FIG. 6 is a plan view of the assembled boiler showing the ribbon cable;

FIG. 7 is a side elevational view in partial section of the assembled boiler; and

FIG. 8 is an enlarged detail of the circled portion of FIG. 7.

### DETAILED DESCRIPTION

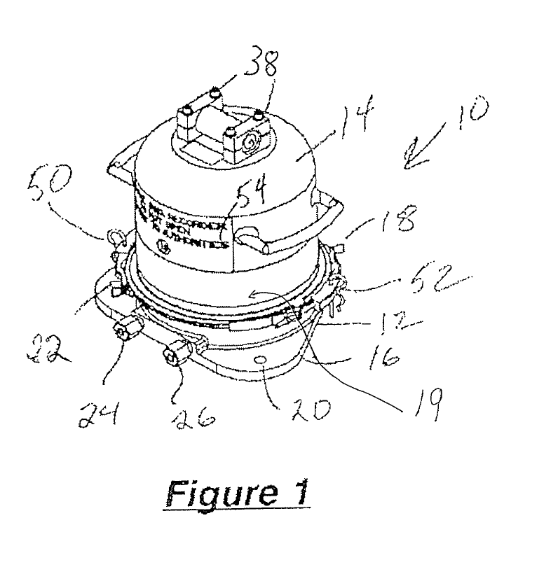

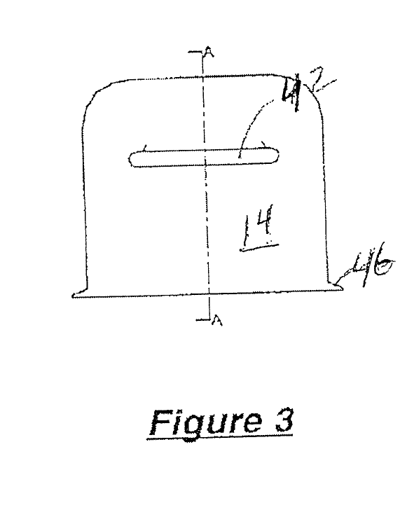

Turning now to FIGS. 1-3, the Hardened Voyage Recorder (HVR) 10 according to the invention includes two separable subassemblies. The first subassembly 12 is a mounting base subassembly designed to be directly fastened to the ship and provide a watertight cable entry for power and data connections. The second subassembly 14 is a removable hardened memory subassembly which is attached to the mounting base with a quick releasing clamp.

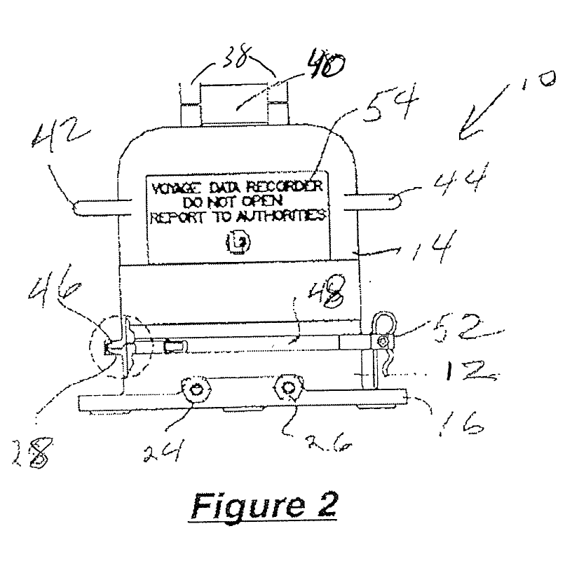

Referring now to the mechanical features of the subassembly 12, as shown in FIGS. 1 and 2, the mounting bas e subassembly 12 has a lower flange 16 defining three mounting holes 18, 20, 22. Two cable gland connectors 24, 26 are provided for a watertight coup ling of power and data cables (not shown). As seen best in FIG. 2, the subassembly 12 is also provided with an upper flange 28 which is used to provide a sealing engagement with the removable hardened memory subassembly 14.

The mechanical features of the hardened memory subassembly 14 include a bracket 38 for an externally mounted underwater location beacon 40. The beacon is preferably provided with dual activation moisture sensors to avoid inadvertent activation due to spray, rain, or hosing off. The subassembly 14 also has two lifting handles 42, 44 and a lower flange 46 which is used to provide a sealing engagement with the subassembly.

The HVR also includes a V-band 48 having two quick release clamps 50, 52. As mentioned above, the HVR is preferably painted a highly visible florescent orange with white reflective labels, e.g. label 54 shown in FIGS. 1 and 2. The reflective labels contain the required (by IEC 61996) text: VOYAGE DATA RECORDER, DO NOT OPEN, REPORT TO AUTHORITIES. A strip of reflective tape, 19, is shown in FIG. 1, further satisfying the requirements of IEC 61996.

The presently preferred embodiment of the HVR 10 is approximately thirteen inches high and has a diameter of approximately eight inches. The lower flange 16 of the subassembly 12 is substantially triangular and is approximately ten inches per side. The total weight of the HVR is approximately forty one pounds with the base 12 weighing approximately thirteen pounds and the memory subassembly 14 weighing approximately twenty eight pounds.

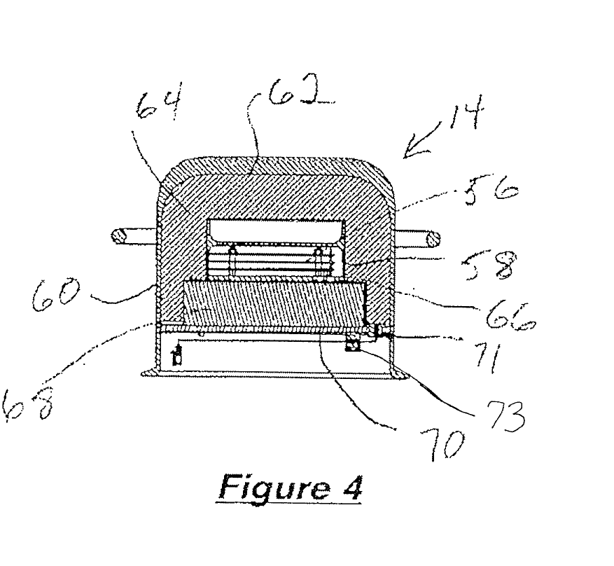

As shown in FIG. 4, the subassembly 14 generally includes memory 56 which is protected in a boiler 58.

More particularly, the subassembly 14 includes a stainless steel bell 60 which is preferably cylindrical in shape and which defines a first interior cylindrical space 62. A first insulating member 64 is disposed in the cylindrical space 62 and defines a second interior cylindrical space 66.

As seen in FIG. 4, the cylindrical space 66 has a stepped configuration. The boiler 58 containing the memory 56 is disposed in the cylindrical space 66. A second insulating member 68 is placed in the cylindrical space 66 covering the boiler 58 and the step of the space 66. The bell 60 is sealed with a stainless steel disk 70 which is held in place by inner and outer snap rings, not shown.

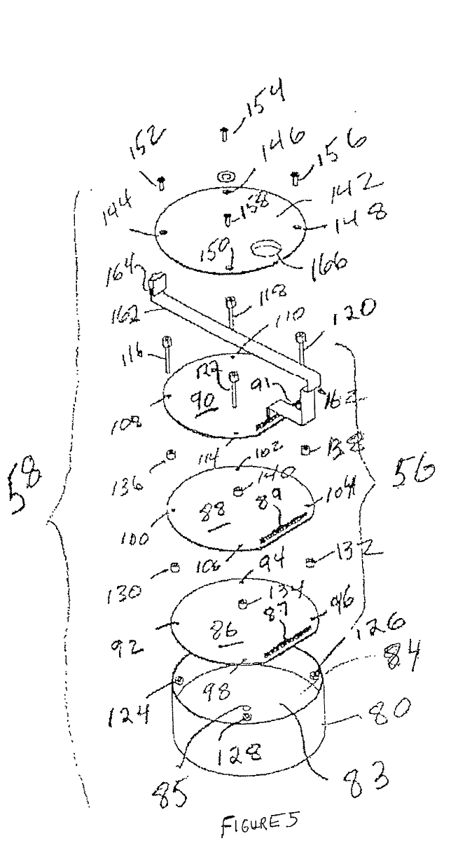

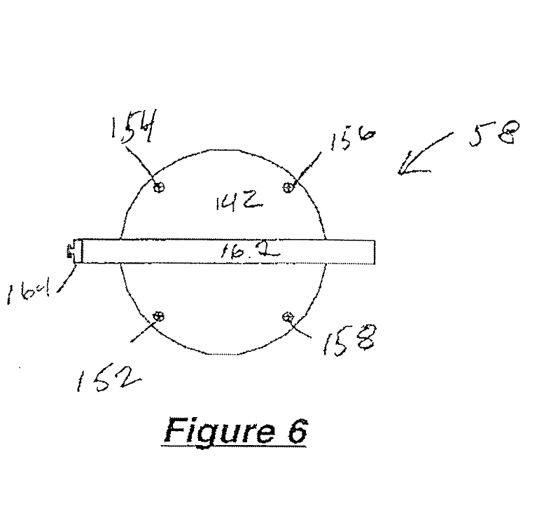

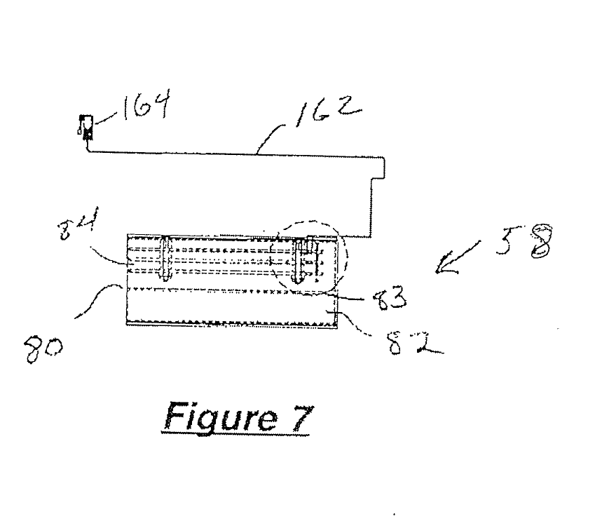

Turning now to FIGS. 5-8, the boiler 58 according to the invention includes a bifurcated cylindrical member 80, one portion of which is a thermal expansion cavity 82 (seen best in FIG. 7) adapted to contain a phase change material or “thermal mass” (not shown) which acts as a heat sink. The other portion 84 of the bifurcated cylindrical member 80 defines a storage compartment for a stacked memory 56. The two portions 82 and 84 are separated by a demising wall 83. The demising wall 83 includes a fusible valve 85 which opens at a predetermined temperature to allow the thermal mass to enter the compartment 84 and protect the memory from fire.

Suitable compounds for use as a thermal mass include water and wax which are both phase change materials. However, the thermal mass need not be a phase change material. It need only be capable of acting as a heat sink. According to a one embodiment of the invention, water is contained in a dry material which inhibits the water from freezing or expanding. Such materials include (for example) sponge, silica, polyacrylamide, calcium silicate or pottery clay. It should be noted that containment compartment 82 for containing a thermal mass may include the a thermal expansion cavity to accommodate expansion of the thermal mass.

Another acceptable thermal mass is a dry powder thermal mass formed by combining water and silica, or a gel formed by combining water and polyacrylamide. The thermal mass created from such compositions inherently absorb shock which provides additional protection for the memory 56 contained in the boiler 80.

According to the presently preferred embodiment, the memory 56 includes three circuit boards 86, 88, 90, each having an electrical coupling 87, 89, 91. Each circuit board preferable provides 512 megabytes of memory assembled from four 128 megabyte BGA memory chips or from sixteen 32 megabyte BGA memory chips (not shown). The total volume of the memory 56 is therefore preferably 1.5 gigabytes. As mentioned in the previously incorporated related application, the memory boards may be advantageously provided with MIC chips to address the memory.

Each memory board is provided with four peripheral mounting holes 92, 94, 96, 98; 100, 102, 104, 106; and 108, 110, 112, 114. The three memory boards 86, 88, 90 are assembled with four screws 116, 118, 120, 122, four nylon nuts (only three of which are seen in FIG. 5) 124, 126, 128 and eight spacers (only six of which are seen in FIG. 5) 130, 132, 134, 136, 138, 140.

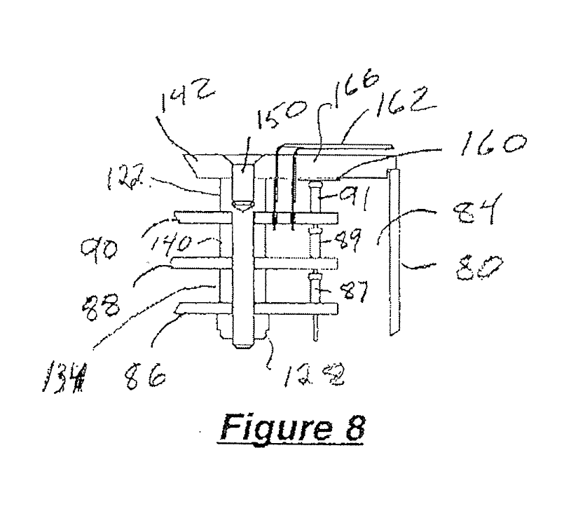

Each of the four screws 116, 118, 120, 120 has a threaded head as seen best with regard to screw 122 in FIG. 8. A cover plate 142 having four peripheral mounting holes 144, 146, 148, 150 is fastened to the threaded heads of the screws 116, 118, 120, 120 by four short screws 152, 154, 156, 158. As seen in FIG. 8, the board to board connectors have a female part on one side of the board and a male part on the other side of the board, thereby permitting any number to be stacked. Accordingly, the connector 91 immediately adjacent to the cover plate 142 is insulated from the cover plate by a piece of tape 160. According to a presently preferred embodiment, the cover plate 142 is press fit into the boiler 80 as seen best in FIG. 8.

According to the presently preferred embodiment, a ribbon cable 162 is hard wired to the last memory board 90 as seen best in FIG. 8. The ribbon cable 162 is preferably provided with a J10 connector 164 for coupling to electronics in the base assembly as described in more detail in the previously incorporated related application filed simultaneously herewith.

According to the presently preferred embodiment, the cover plate 142 is provided with a circular opening 166 which is spaced apart from the edge of the plate. The ribbon cable 162 passes through the opening 166.

As shown in the Figures, and in particular FIG. 4, the cable 162 follows a path through six bends. These bends allow the cable to exit the boiler, route between the two insulators 64, 68 (FIG. 4), exit the bell 60 through an opening 71 in the stainless steel disk 70, move across the bottom of the bell and go down to the electronics subassembly (12 in FIG. 2. In order to relieve stress at the exit opening 71, a cable guide 73 is provided adjacent thereto.

As seen best in FIG. 4, the arrangement of the ribbon cable is such that it need not traverse as much insulation as the cable in the prior art boilers such as the aforementioned '925 patent. According to the invention, the cable is further protected by a silicone rubber pad which is placed between the cable and the insulation.

The removable memory subassembly according to the invention withstands a penetration of a 100 mm 250 kg projectile at three meters. It will withstand a 50 g's, 11 ms half sine shock and an immersion of 6,000 meters depth. The memory will withstand a 260° C. fire for ten hours.

There have been described and illustrated herein a hardened voyage data recorder, a removable memory module assembly, and a boiler for protecting the memory therein. While particular embodiments of the invention have been described, it is not intended that the invention be limited thereto, as it is intended that the invention be as broad in scope as the art will allow and that the specification be read likewise. It will therefore be appreciated by those skilled in the art that certain modifications could be made to the provided invention without deviating from its spirit and scope as so claimed.

What is claimed is:

1. A removable memory module for use with a hardened voyage recorder, said module comprising:
(a) an outer housing including an inner cavity for containing a solid state memory;
(b) a cover for said outer housing;
(c) a thermal insulator located within said inner cavity defining at least a portion of a second interior cavity, with said solid state memory being located within said second inner cavity; and
(d) a boiler located within said second interior cavity including a containment compartment for containing a thermal mass, a protective compartment within which said solid state memory is located and means for interconnecting said containment compartment and said protective compartment, wherein said means for interconnecting, when open, provides a passageway between said containment compartment and said protective compartment, wherein said solid state memory is protected from temperatures on the order of 260° C. for approximately ten hours.

2. A module as set forth in claim 1 wherein solid state memory includes BGA memory.

3. A module as set forth in claim 1 wherein said solid state memory is stacked memory.

4. A module as set forth in claim 1 wherein said boiler includes a cover plate which covers said protective compartment, said cover plate defines a through hole spaced apart from its edge, and said solid state memory is coupled to a cable which extends through said through hole.

5. A module as set forth in claim 4 wherein said through hole is substantially circular.

6. A module as set forth in claim 4 wherein said cover plate is press fit to said boiler.

7. A module as set forth in claim 1 wherein said thermal mass includes a phase change material (PCM).

8. A module as set forth in claim 7 wherein said PCM utilizes the energy absorption from vaporization to absorb heat.

9. A module as set forth in claim 7 wherein said PCM is water.

10. A module as set forth in claim 9 wherein said water is contained in a dry material which inhibits the water from freezing or expanding.

11. A module as set forth in claim 10 wherein said dry material comprises sponge, silica, polyacrylamide, calcium silicate or pottery clay.

12. A module as set forth in claim 7 wherein said thermal mass is a dry powder formed by combining water and silica.

13. A module as set forth in claim 1 wherein said thermal mass absorbs shock.

14. A module as set forth in claim 13 wherein said thermal mass is a gel formed by combining water and polyacrylamide.

15. A boiler as set forth in claim 1 further comprising a fusible valve that opens at a predetermined temperature to allow said thermal mass to flow through said passageway.

16. A boiler as set forth in claim 15 wherein said fusible valve comprises at least one thermal vent plug which is released at a predetermined temperature.

17. A boiler as set forth in claim 16 wherein said thermal vent plug comprises wax, paraffin, a bismuth alloy or electrical solder.

18. A module as set forth in claim 1 wherein said cover for said outer housing is coupled to said outer housing with a snap ring.

19. A module as set forth in claim 18 wherein said cover for said outer housing is coupled to said outer housing with two snap rings.

20. A module as set forth in claim 1 wherein said outer housing withstands a penetration of a 100 mm 250 kg projectile at three meters.

21. A module as set forth in claim 1 wherein said outer housing will withstand a 50 g's, 11 ms half sine shock.

22. A module as set forth in claim 1 wherein said outer housing will withstand an immersion of 6,000 meters depth.

23. A removable memory module for use with a hardened voyage recorder, said module comprising:
(a) an outer housing including an inner cavity for containing a solid state memory;
(b) a cover for said outer housing;
(c) a thermal insulator located within said inner cavity defining at least a portion of a second interior cavity, with said solid state memory being located within said second inner cavity; and
(d) a boiler located within said second interior cavity including a containment compartment for containing a thermal mass, a protective compartment within which said solid state memory is located and means for interconnecting said containment compartment and said protective compartment, wherein said means for interconnecting, when open, provides a passageway between said containment compartment and said protective compartment, wherein said solid state memory includes at least one BGA chip.

24. A module as set forth in claim 23 wherein solid state memory includes a plurality of BGA memory chips.

25. A module as set forth in claim 23 wherein said solid state memory is stacked memory.

26. A module as set forth in claim 23, wherein said boiler includes a cover plate which covers said protective compartment, said cover plate defines a through hole spaced apart from its edge, and said solid state memory is coupled to a cable which extends through said through hole.

27. A module as set forth in claim 26 wherein said through hole is substantially circular.

28. A module as set forth in claim 26 wherein said cover plate is press fit to said boiler.

29. A module as set forth in claim 23 wherein said thermal mass includes a phase change material (PCM).

30. A module as set forth in claim 29 wherein said PCM utilizes the energy absorption from vaporization to absorb heat.

31. A module as set forth in claim 29 wherein said PCM is water.

32. A module as set forth in claim 31 wherein said water is contained in a dry material which inhibits the water from freezing or expanding.

33. A module as set forth in claim 32 wherein said dry material comprises sponge, silica, polyacrylamide, calcium silicate or pottery clay.

34. A module as set forth in claim 29 wherein said thermal mass is a dry powder formed by combining water and silica.

35. A module as set forth in claim 23 wherein said thermal mass absorbs shock.

36. A module as set forth in claim 35 wherein said thermal mass is a gel formed by combining water and polyacrylamide.

37. A boiler as set forth in claim 23 further comprising a fusible valve that opens at a predetermined temperature to allow said thermal mass to flow through said passageway.

38. A boiler as set forth in claim 37 wherein said fusible valve comprises at least one thermal vent plug which is released at a predetermined temperature.

39. A boiler as set forth in claim 38 wherein said thermal vent plug comprises wax, paraffin, a bismuth alloy or electrical solder.

40. A module as set forth in claim 23 wherein said cover for said outer housing is coupled to said outer housing with a snap ring.

41. A module as set forth in claim 40 wherein said cover for said outer housing is coupled to said outer housing with two snap rings.

42. A module as set forth in claim 23 wherein said outer housing withstands a penetration of a 100 mm 250 kg projectile at three meters.

43. A module as set forth in claim 23 wherein said outer housing will withstand a 50 g's, 11 ms half sine shock.

44. A module as set forth in claim 23 wherein said outer housing will withstand an immersion of 6,000 meters depth.

45. A removable memory module for use with a hardened voyage recorder, said module comprising:
(a) an outer housing including an inner cavity for containing a solid state memory;
(b) a cover for said outer housing;
(c) a thermal insulator located within said inner cavity defining at least a portion of a second interior cavity, with said solid state memory being located within said second inner cavity; and
(d) a boiler located within said second interior cavity including a containment compartment for containing a thermal mass, a protective compartment within which said solid state memory is located and means for interconnecting said containment compartment and said protective compartment, wherein said means for interconnecting, when open, provides a passageway between said containment compartment and said protective compartment, wherein said outer housing has an impact strength suitable for use in marine applications.

46. A module as set forth in claim 45 wherein solid state memory includes BGA memory.

47. A module as set forth in claim 45 wherein said solid state memory is stacked memory.

48. A module as set forth in claim 45 wherein said boiler includes a cover plate which covers said protective compartment, said cover plate defines a through hole spaced apart from its edge, and said solid state memory is coupled to a cable which extends through said through hole.

49. A module as set forth in claim 48 wherein said through hole is substantially circular.

50. A module as set forth in claim 48 wherein said cover plate is press fit to said boiler.

51. A module as set forth in claim 45 wherein said thermal mass includes a phase change material (PCM).

52. A module as set forth in claim 51 wherein said PCM utilizes the energy absorption from vaporization to absorb heat.

53. A module as set forth in claim 51 wherein said PCM is water.

54. A module as set forth in claim 53 wherein said water is contained in a dry material which inhibits the water from freezing or expanding.

55. A module as set forth in claim 54 wherein said dry material comprises sponge, silica, polyacrylamide, calcium silicate or pottery clay.

56. A module as set forth in claim 51 wherein said thermal mass is a dry powder formed by combining water and silica.

57. A module as set forth in claim 45 wherein said thermal mass absorbs shock.

58. A module as set forth in claim 57 wherein said thermal mass is a gel formed by combining water and polyacrylamide.

59. A boiler as set forth in claim 45 further comprising a fusible valve that opens at a predetermined temperature to allow said thermal mass to flow through said passageway.

60. A boiler as set forth in claim 59 wherein said fusible valve comprises at least one thermal vent plug which is released at a predetermined temperature.

61. A boiler as set forth in claim 60 wherein said thermal vent plug comprises wax, paraffin, a bismuth alloy or electrical solder.

62. A module as set forth in claim 45 wherein said cover for said outer housing is coupled to said outer housing with a snap ring.

63. A module as set forth in claim 62 wherein said cover for said outer housing is coupled to said outer housing with two snap rings.

64. A module as set forth in claim 45 wherein said outer housing withstands a penetration of a 100 mm 250 kg projectile at three meters.

65. A module as set forth in claim 45 wherein said outer housing will withstand a 50 g's, 11 ms half sine shock.

66. A module as set forth in claim 45 wherein said outer housing will withstand an immersion of 6,000 meters depth.

67. A removable memory module for use with a hardened voyage recorder, said module comprising:
(a) an outer housing including an inner cavity for containing a solid state memory;
(b) a cover for said outer housing;
(c) a thermal insulator located within said inner cavity defining at least a portion of a second interior cavity, with said solid state memory being located within said second inner cavity; and
(d) a boiler located within said second interior cavity including a containment compartment for containing a thermal mass, a protective compartment within which said solid state memory is located and means for interconnecting said containment compartment and said protective compartment, wherein said means for interconnecting, when open, provides a passageway between said containment compartment and said protective compartment, wherein wherein said boiler includes a cover plate which covers said protective compartment, said cover plate defines a through hole spaced apart from its edge, and said solid state memory is coupled to a cable which extends through said through hole.

68. A module as set forth in claim 67 wherein solid state memory includes BGA memory.

69. A module as set forth in claim 67 wherein said solid state memory is stacked memory.

70. A module as set forth in claim 67 wherein said outer housing is capable of withstanding a marine crash environment.

71. A module as set forth in claim 67 wherein said through hole is substantially circular.

72. A module as set forth in claim 67 wherein said cover plate is press fit to said boiler.

73. A module as set forth in claim 67 wherein said thermal mass includes a phase change material (PCM).

74. A module as set forth in claim 73 wherein said PCM utilizes the energy absorption from vaporization to absorb heat.

75. A module as set forth in claim 73 wherein said PCM is water.

76. A module as set forth in claim 75 wherein said water is contained in a dry material which inhibits the water from freezing or expanding.

77. A module as set forth in claim 76 wherein said dry material comprises sponge, silica, polyacrylamide, calcium silicate or pottery clay.

78. A module as set forth in claim 67 wherein said thermal mass is a dry powder formed by combining water and silica.

79. A module as set forth in claim 67 wherein said thermal mass absorbs shock.

80. A module as set forth in claim 71 wherein said thermal mass is a gel formed by combining water and polyacrylamide.

81. A boiler as set forth in claim 67 further comprising a fusible valve that opens at a predetermined temperature to allow said thermal mass to flow through said passageway.

82. A boiler as set forth in claim 81 wherein said fusible valve comprises at least one thermal vent plug which is released at a predetermined temperature.

83. A boiler as set forth in claim 82 wherein said thermal vent plug comprises wax, paraffin, a bismuth alloy or electrical solder.

84. A module as set forth in claim 67 wherein said cover for said outer housing is coupled to said outer housing with a snap ring.

85. A module as set forth in claim 84 wherein said cover for said outer housing is coupled to said outer housing with two snap rings.

86. A module as set forth in claim 67 wherein said outer housing withstands a penetration of a 100 mm 250 kg projectile at three meters.

87. A module as set forth in claim 67 wherein said outer housing will withstand a 50 g's, 11 ms half sine shock.

88. A module as set forth in claim 67 wherein said outer housing will withstand an immersion of 6,000 meters depth.

89. A hardened voyage recorder for use on a marine vessel, comprising:
(a) a first module including a mountable base mountable on the marine vessel and containing electronics for receiving data from data sensors located on the marine vessel and for writing data to a memory module;
(b) a removable memory module removably coupled to said first module, said memory module including
(i) an outer housing including an inner cavity for containing a solid state memory;
(ii) a cover for said outer housing;
(iii) a thermal insulator located within said inner cavity defining at least a portion of a second interior cavity, with said solid state memory being located within said second inner cavity; and
(iv) a boiler located within said second interior cavity including a containment compartment for containing a thermal mass, a protective compartment within which said solid state memory is located and means for interconnecting said containment compartment and said protective compartment, wherein said means for interconnecting, when open, provides a passageway between said containment compartment and said protective compartment.

90. The apparatus as set forth in claim 89 wherein solid state memory includes BGA memory.

91. The apparatus as set forth in claim 89 wherein said solid state memory is stacked memory.

92. The apparatus as set forth in claim 89 wherein said boiler includes a cover plate which covers said protective compartment, said cover plate defines a through hole spaced apart from its edge, and said solid state memory is coupled to a cable which extends through said through hole.

93. The apparatus as set forth in claim 92 wherein said through hole is substantially circular.

94. The apparatus as set forth in claim 92 wherein said cover plate is press fit to said boiler.

95. The apparatus as set forth in claim 89 wherein said thermal mass includes a phase change material (PCM).

96. The apparatus as set forth in claim 95 wherein said PCM utilizes the energy absorption from vaporization to absorb heat.

97. The apparatus as set forth in claim 95 wherein said PCM is water.

98. The apparatus as set forth in claim 97 wherein said water is contained in a dry material which inhibits the water from freezing or expanding.

99. The apparatus as set forth in claim 98 wherein said dry material comprises sponge, silica, polyacrylamide, calcium silicate or pottery clay.

100. The apparatus as set forth in claim 89 wherein said thermal mass is a dry powder formed by combining water and silica.

101. The apparatus as set forth in claim 89 wherein said thermal mass absorbs shock.

102. The apparatus as set forth in claim 101 wherein said thermal mass is a gel formed by combining water and polyacrylamide.

103. A boiler as set forth in claim 89 further comprising a fusible valve that opens at a predetermined temperature to allow said thermal mass to flow through said passageway.

104. A boiler as set forth in claim 103 wherein said fusible valve comprises at least one thermal vent plug which is released at a predetermined temperature.

105. A boiler as set forth in claim 104 wherein said thermal vent plug comprises wax, paraffin, a bismuth alloy or electrical solder.

106. The apparatus as set forth in claim 99 wherein said cover for said outer housing is coupled to said outer housing with a snap ring.

107. The apparatus as set forth in claim 106 wherein said cover for said outer housing is coupled to said outer housing with two snap rings.

108. The apparatus as set forth in claim 89 wherein said outer housing withstands a penetration of a 100 mm 250 kg projectile at three meters.

109. The apparatus as set forth in claim 89 wherein said outer housing will withstand a 50 g's, 11 ms half sine shock.

110. The apparatus as set forth in claim 89 wherein said outer housing will withstand an immersion of 6,000 meters depth.

111. The apparatus as set forth in claim 89 wherein said solid state memory is protected from temperatures on the order of 260° C. for approximately ten hours

112. A process for fabricating a removable memory module for a hardened voyage recorder, comprising the steps of:
(a) fabricating a boiler that includes a containment compartment for storing a thermal mass and a separate protective compartment for housing an electronic memory device to be protected from heat, moisture and shock;
(b) filling said containment compartment with a thermal mass;
(c) placing said electronic memory device in said protective compartment;
(d) housing said boiler in a covered outer housing that includes, within said covered outer housing, a thermal insulator defining a cavity within which to situate and protect said boiler; and
(e) providing a cable passageway formed in said thermal insulator, said cable passageway extending to and thru said covered outer housing; such that said electronic memory device is protected from the environment of a marine crash.

113. A process as set forth in claim 112 wherein said electronic memory is protected from temperatures on the order of 260° C. for approximately ten hours.

114. A process as set forth in claim 112 wherein said electronic memory includes BGA memory.

115. A process as set forth in claim 112 wherein said boiler includes a cover plate which covers said protective compartment, said cover plate defines a through hole spaced apart from its edge, and said solid state memory is coupled to a cable which extends through said through hole.

116. A process as set forth in claim 115 wherein said cover plate is press fit to said boiler.

117. A process as set forth in claim 112 wherein said outer housing withstands a penetration of a 100 mm 250 kg projectile at three meters.

118. A process as set forth in claim 112 wherein said outer housing will withstand a 50 g's, 11 ms half sine shock.

119. A process as set forth in claim 112 wherein said outer housing will withstand an immersion of 6,000 meters depth.

120. A boiler for protecting a memory module located within a hardened voyage recorder from low temperature fires, comprising:
(a) a containment compartment for containing a thermal mass;
(b) a protective compartment within which said memory module is located; and
(c) means for interconnecting said containment compartment and said protective compartment, wherein said means for interconnecting, when open, provides a passageway for said thermal mass to flow between said containment compartment and said protective compartment and protect said memory module from temperatures on the order of 260° C. for approximately ten hours.

121. A boiler as set forth in claim 120 wherein memory module includes solid state BGA memory.

122. A boiler as set forth in claim 120 wherein said memory module is stacked memory.

123. A boiler as set forth in claim 120 wherein said boiler further includes a cover plate which covers said protective compartment.

124. A boiler as set forth in claim 123 wherein said cover plate is press fit to said boiler.

125. A boiler as set forth in claim 120 wherein said thermal mass includes a phase change material (PCM).

126. A boiler as set forth in claim 125 wherein said PCM utilizes the energy absorption from vaporization to absorb heat.

127. A boiler as set forth in claim 125 wherein said PCM is water.

128. A boiler as set forth in claim 127 wherein said water is contained in a dry material which inhibits the water from freezing or expanding.

129. A boiler as set forth in claim 128 wherein said dry material comprises sponge, silica, polyacrylamide, calcium silicate or pottery clay.

130. A boiler as set forth in claim 125 wherein said thermal mass is a dry powder formed by combining water and silica.

131. A boiler as set forth in claim 120 wherein said thermal mass absorbs shock.

132. A boiler as set forth in claim 131 wherein said thermal mass is a gel formed by combining water and polyacrylamide.

133. A boiler as set forth in claim 120 further comprising a fusible valve that opens at a predetermined temperature to allow said thermal mass to flow through said passageway.

134. A boiler as set forth in claim 133 wherein said fusible valve comprises at least one thermal vent plug which is released at a predetermined temperature.

135. A boiler as set forth in claim 134 wherein said thermal vent plug comprises wax, paraffin, a bismuth alloy or electrical solder.

136. A boiler for protecting a memory module located within a hardened voyage recorder from low temperature fires, comprising:
(a) a containment compartment for containing a thermal mass;
(b) a protective compartment within which said memory module is located; and
(c) means for interconnecting said containment compartment and said protective compartment, wherein said means for interconnecting, when open, provides a passageway for said thermal mass to flow between said containment compartment, wherein said boiler includes a cover plate which covers said protective compartment, said cover plate defining a through hole spaced apart from its edge, and said memory module is coupled to a cable which extends through said through hole.

137. A process for fabricating a boiler used to contain and protect a removable memory module for a hardened voyage recorder, comprising the steps of:
(a) fabricating a containment compartment for storing a thermal mass;
(b) fabricating a separate protective compartment for housing an electronic memory device to be protected from heat, moisture and shock;
(c) filling said containment compartment with a thermal mass;
(d) placing said electronic memory device in said protective compartment;
(d) covering said protective compartment with a cover plate including a through hole spaced apart from its edge; and
(e) coupling said memory module to a cable which extends through said through hole.

138. A method as set forth in claim 137 further comprising the step of utilizing a press fit cover to cover said protective compartment.

139. A method as set forth in claim 137 further comprising the step of interconnecting said containment compartment and said protective compartment with means that when open provides a passageway for said thermal mass to flow between said containment compartment and said protective compartment.

140. A method as set forth in claim 137 wherein said process is utilized to fabricate a boiler that is able to protect said memory module from temperatures on the order of 260° C. for approximately ten hours.

141. A method as set forth in claim 137 wherein said thermal mass is a phase change material.
